(19) United States
(12) Patent Application Publication
(10) Pub. No.: US 2026/0202021 A1
(43) Pub. Date: Jul. 16, 2026

(54) VESSELS AND METHODS FOR STORING AND DELIVERY A REAGENT

(71) Applicant: ENTEGRIS, INC., Billerica, MA (US)

(72) Inventors: Oleg Byl, Southbury, CT (US); Douglas Edwards, Pawling, NY (US); Jessica Verbisky, Marlborough, MA (US)

(21) Appl. No.: 19/431,851

(22) Filed: Dec. 23, 2025

Related U.S. Application Data
(63) Continuation of application No. 17/732,446, filed on Apr. 28, 2022.
(60) Provisional application No. 63/182,536, filed on Apr. 30, 2021.

(51) Int. Cl. F17C 13/04; F17C 13/02

(52) U.S. Cl. CPC F17C 13/04; F17C 13/021; F17C 2201/0109; F17C 2203/0391; F17C 2203/0629; F17C 2205/0329; F17C 2223/0153; F17C 2223/033

(57) ABSTRACT

A storage vessel to contain reagent material. The storage vessel includes a vessel with a bottom, a top, an outlet at the top, sidewalls extending from the bottom to the top, a valve at the outlet, and an interior defined by the bottom, the top, and the sidewalls, the interior including a volume, and an extension tube having a first end engaged with the valve and a second end located toward a center of the interior volume from the first end such that, regardless of orientation of the vessel, the second end is above at least 25 percent of a volume of the interior volume.

### FIELD

The invention relates generally to storage and dispensing systems and related methods for storing and selectively dispensing a gaseous reagent material in the form of a reagent gas from a vessel in which the reagent material is contained in both a gaseous form and a liquid form.

### BACKGROUND

Gaseous chemicals that are stored in the form of a gas, or a volatile liquid, or volatile solid but delivered to a point of use in a form of a gas are used as raw materials for a range of commercial processes, in many different areas of technology. As a single example, high purity gaseous chemicals, sometimes referred to as “reagent gases,” are used for manufacturing microelectronic and semiconductor devices.

Typical gas storage systems for high purity gases include compressed, liquefied, refrigerated, dissolved, and adsorbed gas storage systems. A compressed gaseous storage system is as it sounds, a storage vessel that stores a gaseous raw material in the vessel at a pressure and density that do not cause any fraction of the reagent material to condense into liquid or solid form. A liquefied gas storage system is a vessel containing a gaseous material at a pressure and density that cause liquefaction of a fraction of the material. A refrigerated gas storage system is a vessel containing gaseous material at temperatures below room temperature, at which a fraction of the material is liquefied. A dissolved gas storage system contains a solvent that dissolves a portion of a gaseous material. An adsorbed gas storage system contains a media capable of adsorbing gaseous material and reducing its pressure. Delivery of the reagent as gas is done by applying pressure below the vessel pressure.

Typical storage systems for a high purity liquid or solid include a vessel in which a liquid or solid reagent is stored under its own saturated vapor pressure or under a blanket of inert gas. Delivery of the reagent as a gas is done by applying pressure below the saturated vapor pressure or by using a carrier gas that is flowed through the storage vessel.

All types of storage systems must store a pure chemical reagent within a storage vessel at a pressure that allows the gas to be reliably removed from the vessel at a useful flow rate and pressure. The chemical reagent can be contained within the vessel at a storage pressure that is lower or greater than one atmosphere and can be dispensed from the vessel at a useful pressure at or below the storage pressure. In cases when the storage pressure of the reagent within the vessel is insufficient to sustain a useful flow rate or pressure of the gas from the vessel, optional heating can be provided to the vessel.

Manufacturers use various reagents stored in storage systems suitable for transportation, handling, and supplying the reagent to manufacturing equipment as a gas. The reagent must be delivered in the form of a highly pure gas, and must be supplied in an efficient, predictable, and dependable manner. Many types of reagent materials may be stored in a vessel that contains the reagent material in a liquid phase as well as a gas phase. This is done to achieve desirable quantity of reagent material necessary for a certain duration of use of a storage vessel. Delivering a gas phase of the reagent material from the vessel should be accomplished without the liquid phase entering the delivery channel of the gas. Upon entering the gas delivery channel, the liquid phase of the reagent material may propagate further into the manufacturing equipment and cause process inefficiency, equipment damage, or manufacturing item defects.

Many storage systems used to deliver a reagent for manufacturing semiconductor devices include a portable vessel suitable for transportation by a single operator, and typically do not exceed 50 liters by volume. These vessels typically have a single channel for delivery of reagent gas equipped with a valve. During transportation or handling, the vessel is often placed in an orientation different from that used during dispensing the reagent as a gas. This can result in temporary entry of a liquid phase into a gas phase delivery channel.

In some cases, design of manufacturing equipment requires the placement of a reagent vessel in various orientations, which can result in liquid phase entry into a gas delivery channel. Accordingly, a storage vessel may desirably be designed with features to prevent the liquid phase from entering into a gas delivery channel.

Typically, to prevent a liquid phase from entering a gas delivery channel (e.g., a valve through which the gaseous reagent material flows to a point of use), the gas phase is extracted from the top portion of the vessel, with the liquid phase settling at the bottom. This can be challenging when the container is positioned horizontally, or upside-down, or is otherwise handled in a manner that causes a liquid phase to contact and potentially fill or block a gas phase delivery channel.

### SUMMARY

According to the following description, a storage vessel that contains reagent material in both a liquid phase and a gas phase also includes an extension tube that extends from an opening of the vessel, e.g., a valve, to an interior portion at a central (axial) location of the interior of the vessel. The extension tube has an opening at the end located at the central location, and is positioned with the open end always being located above a level of a liquid phase that is contained in the vessel, regardless of the orientation of the vessel. The function of the extension tube is to prevent the liquid from entering the valve and to facilitate and ensure only gas phase delivery from the vessel.

In one aspect, the invention relates to a storage vessel that contains reagent material. The storage vessel includes: a vessel that includes a bottom, a top, an outlet at the top, sidewalls extending from the bottom to the top, a valve at the outlet, and an interior defined by the bottom, the top, and the sidewalls. The vessel contains reagent material at the interior, including a portion of the reagent material as a liquid phase and a portion of the reagent material as a gaseous phase. The vessel includes an extension tube having a first end engaged with the valve and a second end at a location of the interior that does not allow contact with the liquid phase, with the vessel in any orientation including: in an upright orientation; in a horizontal orientation, or in an upside-down orientation.

In another aspect, the invention relates to a storage vessel that contains liquid reagent material in a vessel with an extension tube that can optionally house a liquid blocking component such as frit, filter, check valve, regulator, or any other suitable element capable of preventing liquid propagation up the gas delivery channel. These liquid blocking components may provide additional benefits such as regulating delivery of reagent gas from the vessel.

In another aspect, the invention relates to a storage vessel that contains liquid reagent material in a vessel with an extension tube, and with heat transfer features located in the interior of the vessel fully or partially immersed into the liquid to increase the rate of heat transfer from the vessel walls to the bulk of the liquid to facilitate the rate of evaporation and replenish the gas phase with gaseous reagent during material dispensing for use in manufacturing equipment.

In another aspect, the invention relates to a method of supplying reagent material to a semiconductor processing apparatus. The method includes connecting a storage vessel to a semiconductor processing apparatus. The storage vessel includes a vessel comprising a bottom, a top, an outlet at the top, sidewalls extending from the bottom to the top, a valve at the outlet, and an interior defined by the bottom, the top, and the sidewalls. The vessel contains reagent material at the interior, including a portion in a liquid phase and a portion in a gaseous phase. The vessel includes an extension tube having a first end engaged with the valve and a second end at a location of the interior that does not allow contact with the liquid phase, with the vessel in any orientation including: in an upright orientation; in a horizontal orientation, and in an upside-down orientation. The method includes allowing reagent material in the gaseous phase to flow from the storage vessel to the semiconductor processing apparatus.

In another aspect, the invention relates to a method of adding reagent material to a storage vessel. The method comprising adding liquid reagent material to a storage vessel that comprises: a bottom, a top, an outlet at the top, sidewalls extending from the bottom to the top, and an interior defined by the bottom, the top, and the sidewalls. The vessel also includes an extension tube having a first end engaged with the valve and a second end that is located axially from the sidewalls and at a distance in a range from 25 to 75 percent of the height of the vessel. The method includes adding the liquid reagent material to the interior to a level of the liquid that is below the second end of the extension tube with the vessel in any orientation, including: in an upright orientation; in a horizontal orientation, and in an upside-down orientation.

In yet another aspect, the invention relates to a storage vessel that can be used to store reagent material in a liquid phase and a gas phase. The storage vessel includes: a bottom, a top, an outlet at the top, sidewalls extending from the bottom to the top, an interior defined by the bottom, the top, and the sidewalls, and a valve at the outlet. The storage vessel also includes an extension tube having a first end engaged with the valve and a second end that is located axially from the sidewalls and at a distance in a range from 25 to 75 percent of the height of the vessel.

### BRIEF DESCRIPTION OF THE DRAWINGS

FIGS. 1A, 1B, and 1C show side views of a storage vessel as described, at different positional orientations.

FIG. 2 shows a graph of a maximum amount of liquid by volume that may be contained in a storage vessel having an extension tube as described, at different orientations.

### DETAILED DESCRIPTION

The present description relates to storage vessels that contain a reagent material in a gas form and in a liquid form, as well as methods of preparing and using these storage vessels to store and deliver a reagent gas.

A storage vessel as described contains a reagent material that is contained in the vessel in both a liquid phase and a gas phase (the gas phase being referred to herein as a “reagent gas”). The vessel includes an internal volume that is enclosed by a vessel bottom, sidewalls, and a top. At the top of the vessel is a valve that can be selectively opened and closed to allow reagent gas to be removed from the vessel interior.

To prevent the liquid phase that is contained in the vessel from interfering with delivery of the gas phase from the vessel through the valve, the vessel includes an extension tube that extends from the valve to a central location of the internal volume of the vessel. A central location relative to the sidewalls is an axial location, meaning a location along a longitudinal axis of the vessel, which is also a location that is generally centrally located relative to the sidewalls, meaning substantially equidistant from all sidewalls of a cylindrical vessel. Relative to the ends (top and bottom) of the vessel, a central location is a location generally at a middle portion of the interior of the vessel compared to the top and the bottom, e.g., a portion mid-way between the bottom and the top of the interior of the vessel. As an example, an open end of the extension tube may be located at a distance that is from 25 to 75 percent of the height of the interior volume, or from 40 to 60 percent of the height, or from 45 to 55 percent of the height. In an embodiment, the open end of the extension tube is located approximately halfway between the top and bottom of the vessel. The open end of the extension tube may be a circular opening or a non-circular opening.

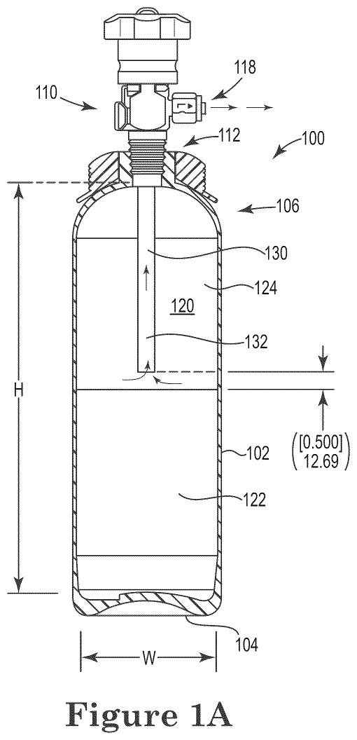

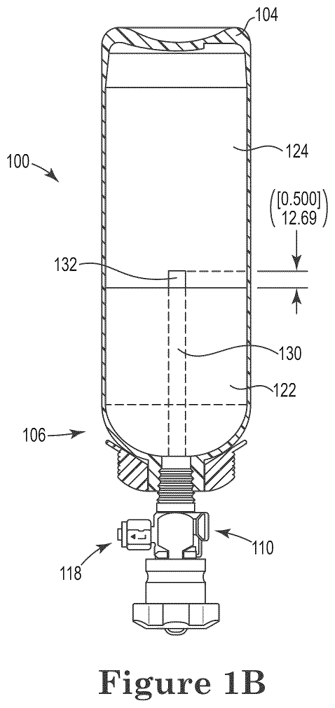

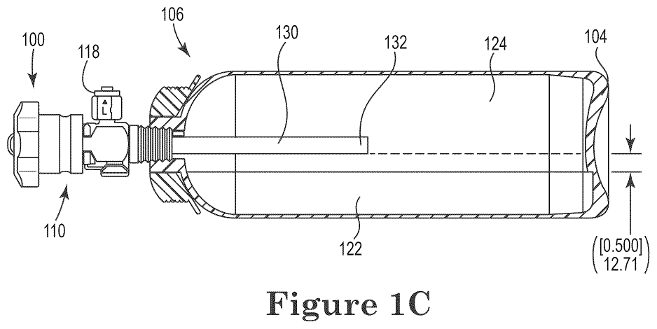

For these purposes, the “height” of the interior volume of the vessel is measured from a bottom of an interior of a vessel at a bottom of sidewalls of the vessel, to a top of the interior volume at a top of the sidewalls of the vessel. For a vessel that includes a rounded or a domed sidewall at a top portion of the vessel near the outlet, and typically also a neck at the outlet that engages the valve, the height of the interior volume is measured from the bottom of the volume to the top of the rounded portion of the volume (see FIG. 1A), which generally coincides with a bottom of a neck or a valve of the vessel. An interior volume of the vessel is also measured based on this “height” of the interior volume.

In addition to the extension tube end being located at a central location, a vessel as described contains an amount (volume) of the liquid phase of the reagent material that does not reach the location of a centrally-located open end of the extension tube, regardless of the orientation of the vessel. For example, the vessel may contain liquid phase reagent material in an amount that places the liquid-gas interphase of the reagent material at a level that is less than 49 percent of the height of the interior volume of the vessel standing upright (see FIG. 1A), such as is less than 45, 40, 35, 30, or 25 percent of the height of the interior volume of the vessel, standing upright.

Considered differently, the vessel may contain liquid phase reagent material in an amount of not more than about 49 percent of a total internal volume of the vessel, such as an amount by volume that is less than 45, 40, 35, 30, or 25 percent of the total volume of the vessel. This determination of the volume occupied by the liquid phase reagent material may be at room temperature or at the use temperature.

Still differently, the vessel may contain an amount of the liquid phase reagent material so that the liquid phase does not contact the end of the extension tube, in any orientation of the vessel, including: with the vessel oriented vertically (see FIG. 1A) the liquid surface is at least one quarter or one half inch below the open end of the extension tube, and with vessel oriented upside-down (see FIG. 1B) the liquid surface is at least one quarter or one half inch below the open end of the extension tube, and with the vessel oriented horizontally (see FIG. 1C) the liquid surface is at least one quarter or one half inch below the open end of the extension tube.

The extension tube is an elongate tube that includes one end that is connected directly or indirectly in a fluid-tight manner to the valve. From the valve, the tube extends axially into the vessel interior to a second end that is open to the vessel interior and located at the central location. The second (open) end of the extension tube is placed at a generally central position of the vessel interior, at a central location of the vessel, to prevent the liquid that is contained in the vessel from contacting or entering the open end of the tube, regardless of the orientation of the vessel. Placing the open end of the tube centrally within the volume of the vessel, and with the vessel containing a limited volume of the liquid reagent material, can prevent liquid phase reagent material from interfering with delivery of the gas phase reagent material and ensure that only the gas phase of the reagent material contacts the valve or extension tube. The extension tube may be of a material that is inert to the liquid reagent material and the gas phase reagent. In a non-limiting example, the extension tube may be stainless steel (e.g., 316) or a fluoropolymer. Other suitable materials may include inert metals and polymers. In an embodiment, the extension tube may have a surface finish or coating to enhance the resistance to corrosion. The extension tube may be electropolished. The extension tube may be plated with a nickel electroplated coating. The extension tube may have a polytetrafluoroethylene (PTFE) coating applied to the tube.

With an extension tube as described, in a storage vessel, reagent gas located at the vessel interior is able to flow into the open end of the extension tube located at the central location of the vessel. Also, the open end of the tube is positioned centrally within the vessel interior, at a location that is above the level of the liquid reagent material regardless of vessel orientation.

Referring to FIGS. 1A, 1B, and 1C, illustrated is an example vessel as described. Vessel 100 includes sidewalls 102, bottom 104, domed top 106, vessel outlet 112 at the top (or “neck”) of the vessel, and valve 110 at outlet 112. Height “H” of the interior volume is measured from the bottom to the top of domed top 106. Interior volume 120 includes liquid reagent material 122 in a liquid phase, and vapor reagent material (reagent gas) 124 as a gaseous phase in a space above the liquid phase. Extending down from valve 110 toward bottom 104 is extension tube 130. Extension tube 130 is in fluid-tight communication, directly or indirectly, with valve 110, and extends down along an elongate hollow, closed length of tube to an opening at open end 132.

In use, valve 110 may be selectively opened and closed to release reagent gas 124 from interior volume 120. When valve 110 is selectively opened, reagent gas 124 can be caused to flow into open end 132 of extension tube 130 using to a pressure differential created between interior volume 120 and a valve exterior. Reagent gas 124 flows up and through extension tube 130 to exit valve 110 at valve outlet 118.

As illustrated, vessel 100 is oriented in an upright and vertical orientation. The volume of liquid reagent material 122 is less than half of the total volume of interior 120 of vessel 100. At this low amount by volume relative to the total volume of interior 120, the level of the liquid reagent material 122, i.e., the interface between liquid phase 122 and gas phase reagent material 124, is below open end 132 of extension tube 130. Liquid phase 122 does not and is not able to contact open end 132 of extension tube 130 by changing the orientation of vessel 100.

Referring to FIG. 1B, numerical designations of FIG. 1B are the same as those of FIG. 1A. In FIG. 1B, vessel 100 is shown in an inverted (upside-down) orientation. The volume of liquid reagent material 122 is, again, less than half of the total volume of interior 120 of vessel 100, but is located at the inverted “top” portion of vessel 100. Because of the low amount by volume of liquid phase 122 relative to the total volume of interior 120, and with the location of open end 132 centrally within interior 120, the level of liquid reagent material 122 is below open end 132 of extension tube 130, and is not able to contact open end 132 even in the illustrated inverted orientation.

Referring to FIG. 1C, numerical designations of FIG. 1C are the same as those of FIG. 1A. In FIG. 1C, vessel 100 is shown in sideways (horizontal) orientation. The volume of liquid reagent material 122 is, again, less than half of the total volume of interior 120 of vessel 100, but is located along the length of horizontally oriented vessel 100 between bottom 104 and top 106. Because of the low amount by volume of liquid phase 122 relative to the total volume of interior 120, and with the location of open end 132 centrally within interior 120, the level of liquid reagent material 122 is below open end 132 of extension tube 130, and is not able to contact open end 132 even in the illustrated horizontal orientation of vessel 100.

Typically, and as illustrated, a storage vessel for reagent materials is a cylinder with cylindrical sidewalls, a top (typically domed or extended, but also optionally flat), and a bottom (typically substantially flat) that are seamlessly connected and formed in an appropriate cylinder production process. Cylinders are efficient and are a standard form of pressurized and non-pressurized storage vessels for industrial reagent materials, so systems of the present description will be adaptable to cylindrical storage vessels. Still, the presently-described storage systems and vessels may also involve storage vessels that are non-cylindrical, by use of an extension tube as described being located centrally within an interior volume of the vessel, in combination with a volume of liquid phase reagent material within the vessel interior that is less than about 49 percent of a total internal volume of the vessel, such as an amount by volume that is less than 45, 40, 35, or 30 percent of the total volume of the vessel.

The vessel as illustrated and as generally described can be a rigid container with rigid sidewalls, a rigid top and bottom, and an opening at the top to which a valve or other dispensing device can be attached. The bottom can be generally flat and the top may be flat, curved, rounded, domed, or elongated. The sidewalls, bottom, and a top are made of a rigid material such as a metal (carbon steel, stainless steel, aluminum), fiberglass, or rigid polymer. For storing a reagent material at low pressure, the vessel is not required to be adapted to contain contents at high pressure.

The interior surfaces of the cylinder sidewalls, top, and bottom can be finished in any appropriate way to reduce their true surface area arising from non-flat surface morphology at microscopic level, and treated to render the interior surface clean and non-reactive to ensure high purity of the reactant material. Examples of such finishing and treatment include abrasive blasting, polishing, grinding, sanding, electropolishing, electroplating, electroless plating, coating, galvanizing, anodizing, etc. Some non-limiting examples of coatings include alumina and polytetrafluoroethylene (PTFE). A non-limiting example of a plating is electroless nickel.

The “valve” may be any dispensing device that can be selectively opened and closed to allow flow of reagent gas between the vessel interior and a vessel exterior. A valve may be of any type, with a diaphragm valve being a useful example. Associated with the valve either internal or external to the vessel may be various flow control devices such as a filter, pressure regulator, pressure gauge, flow regulator, etc. In certain useful and preferred examples of vessels as described, interior of the vessel does not contain any one or more of a filter, pressure regulator, pressure gauge, flow regulator, or other flow control device, other than the extension tube attached to the valve at the outlet.

Reagent gas can be removed from the vessel interior through a valve by known techniques, including by drawing the reagent gas out of the interior, through the valve, by reduced pressure (vacuum) applied at the valve. The reduced pressure produced at the valve can be a pressure that is below the internal pressure of the storage vessel.

Optionally, the vessel may be heated to an elevated temperature (e.g., 25, 30, 40, 50, 60, 70, 80, 90, 100, 130, or 150 degrees Celsius) to increase the vapor pressure of a reagent material stored in the vessel, to facilitate delivery of the reagent gas from the vessel.

Also to facilitate dispensing of a low vapor pressure reagent gas, components of a dispensing system such as a valve, the extension tube, and related items such as a filter or pressure or flow regulator may have flow passages that are of a larger size compared to comparable equipment used for other types of gas storage and delivery systems, such as compressed, liquefied, refrigerated, dissolved gas systems, which contain the reagent material in the interior at a higher pressure. In one embodiment, the extension tube is a half inch in outer diameter. The extension tube may be other sizes, for example, a quarter inch in outer diameter.

The use of a diaphragm valve that can be selectively opened and closed, to allow reagent gas to enter and exit the vessel, can be preferred relative to other types of valves such as butterfly valves, gate valves, ball valves, etc. A diaphragm valve is a type of valve that includes a passage that can be selectively opened and closed, and sealed or un-sealed to control a flow of a fluid (liquid or gas) through the passage by movement of a flexible “diaphragm” material, e.g., a flexible “sheet” that is positioned to selectively open and close the passage. The flexible diaphragm material may be a natural or synthetic elastomeric material such as a rubber, silicone, or other flexible or elastomeric polymer, or flexible metal. The flexible diaphragm material may be in the form of a sheet that is positioned within a passage, that may be moved within the passage to alternately, selectively, open or close (block) the passage. Movement of the flexible diaphragm material may be controlled mechanically, pneumatically, hydraulically, electrically, etc.

For use in a storage vessel as described, a diaphragm valve offers advantages of allowing for high flow through the valve, high purity, leak tightness, high range of operating pressures, and reliability. The high purity is provided by reduced surface area of the wetted valve surface, to reduce the potential for introducing impurities into a flow of gas through the valve. Leak tightness is delivered by a metal-to-metal seal of the diaphragm and use of an elastomer-to-metal or metal-to-metal seal in the valve flow control element. By design, diaphragm valves offer operating pressure range from vacuum, e.g., 10⁻⁵ Torr, to hundreds of psi pressure, e.g., 625 psig or above. Reliability of a diaphragm valve can result from a precisely machined diaphragm that ensures leak-free performance over multiple open-close cycles.

A vessel as described may either include a single port that is used to both fill the vessel and deliver gas from the vessel. Alternately, a vessel may include two ports, one used to fill the vessel and one used to deliver gas from the vessel. In an embodiment, the vessel may further comprise a carrier gas inlet port to provide a carrier gas to the vessel. The carrier gas may be an inert gas such as argon, helium, nitrogen. The carrier gas may be heated and assist in vaporizing the liquid reagent.

In useful or preferred examples of a vessel, the valve and any associated vapor delivery devices can be useful to supply a steady flow of gas at a pressure equal to or below a pressure of the vessel interior, e.g., at a pressure in a range from 10, 20, 50, or 100 Torr up to 200, 300, 500 torr or 760 Torr (1 atmosphere) (at 20 degrees Celsius). A useful flow rate at these temperature and pressure conditions can be below 100 standard cubic centimeters per minute (sccm), e.g., from 1 to 100 sccm, or from 2, 5, or 10 sccm up to or in excess of 20, 50, or 80 sccm.

Also as illustrated and as generally described, a vessel interior may be empty or substantially empty other than the reagent material (liquid and gas phases), extension tube, and other items or devices needed to deliver the reagent gas from the vessel to an exterior location. The vessel may be equipped with heat transfer features such as solid foam, fins, baffles, rods, disks, etc., whose role is to increase heat transfer from the vessel walls to the bulk of the liquid. These heat transfer feature may be needed for liquid that exhibits high heat of evaporation, low pressures, or when used in a high flow application.

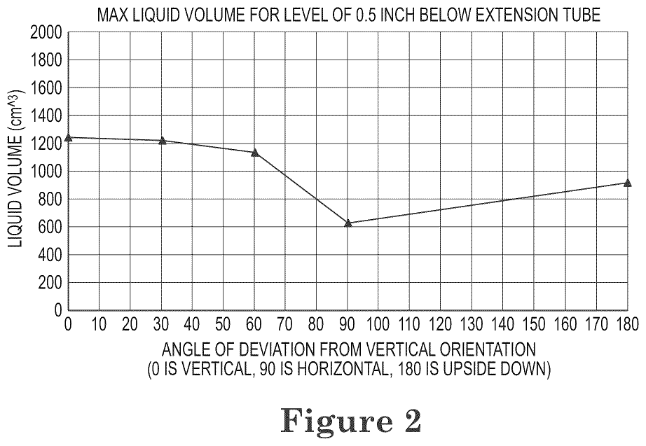

Referring to FIG. 2, this is a graph of a maximum amount of liquid volume that can be contained in a storage vessel as described, having an extension tube as described, over different orientations from vertical (0 degrees), to horizontal (90 degrees), to upside-down (180 degrees).

The exemplary vessel is a cylinder that has a total volume of 2.2 liters, an internal height of 11 inches, an internal diameter of 3.7 inches, domed upper sidewalls, a dimpled bottom, a valve at the top, and a one-half inch diameter extension tube extending from the valve to place an open end of the extension tube at an axial location that is approximately mid-way along the height of the vessel.

The graph shows a maximum liquid volume that can be contained in the vessel, at the various orientations, with the upper surface of the liquid remaining at least one-half inch away from contacting the open end of the extension tube. The maximum amount of liquid that can be contained by the vessel at the various orientations is different for the different orientations, because of the domed shape of the upper sidewalls and because of the dimpled bottom. The horizontal orientation (90 degrees) requires the lowest liquid volume to avoid contact with the open end of the extension tube.

A reagent material contained in a vessel can be any reagent material that can be contained in the vessel in a gas phase and in a liquid phase, when held at a temperature within a range typically used to store and deliver reagent materials. The internal pressure of the vessel will depend on the reagent material and temperature. The internal pressure can be above atmospheric pressure (e.g., up to or exceeding 2, 3, 5, or 10 atmospheres), or below atmospheric pressure (e.g., below 760 Torr, or below 500, 300, 200, 100, 50, or 25 Torr or lower), e.g., as measured at 70 degrees Fahrenheit.

The present vessel can be particularly useful to deliver gases that are stored as liquids that exhibit a relatively low vapor pressure. Low vapor pressure liquid reagents may be efficiently delivered from a vessel as described, while avoiding or preventing contact between the liquid phase of the reagent material and any of the structure used to dispense the reagent gas from the vessel, e.g., the valve.

In particular applications, but without limiting the present description, a reagent material may be of a type useful for semiconductor or microelectronic processing equipment. More specifically, the reagent gas may be provided to an ion implantation system for implanting ions into semiconductor wafers.

Typically, a reagent material can be one that is liquid at room temperature, or within a range about room temperature (e.g., from 10 to 50 degrees Celsius) when contained in the storage vessel. The pressure within the storage vessel will be equal to the vapor pressure (saturated vapor pressure) of the reagent material, at the storage temperature. Accordingly, the reagent material may be contained in the storage vessel at any internal pressure, which will be a function of the type of the reagent material (particularly the saturated vapor pressure that is characteristic of the reagent material), and the temperature of the storage vessel. The “internal pressure” of the vessel refers to a pressure of the gaseous phase (the saturated vapor pressure of the reagent material) at the interior of the storage vessel that contains the reagent material in liquid and gaseous phase, at an operating temperature of the storage vessel.

The temperature at which the vessel is held for dispensing reagent gas from the vessel (the “operating temperature”) may be any temperature at which the storage vessel can be connected to manufacturing equipment to which the reagent gas will be delivered, e.g., a semiconductor processing apparatus, such as an ion implantation apparatus. A typical range of operating temperatures may be from below room temperature (e.g., 5, 10, or 15 degrees Celsius) to an elevated temperature to which the storage vessel may be heated during use to facilitate delivery of reagent gas from the storage vessel, e.g., 25, 30, 40, 50, 100, or 120 degrees Celsius. A typical operating temperature range is from room approximately room temperature to a slightly elevated temperature, e.g., from 18 to 40 or 50 degrees Celsius.

According to non-limiting examples, reagent material useful in a vessel as described may have a vapor pressure that exceeds one atmosphere, at useful operating temperature, e.g., in a range from 1 atmosphere (760 Torr) to 3, 5, or 10 atmospheres.

The presently described storage systems, however, are particularly useful or advantageous as a system for storing and dispensing reagent materials that have a low vapor pressure at an operating temperature, e.g., for storing and dispensing low pressure liquefied materials. These types of reagent materials may have a vapor pressure (saturated vapor pressure) that is below 760 Torr, e.g., below 500, 300, 200 Torr, 100 Torr, 50 Torr, 20 Torr, or 10 Torr, at a desired operating temperature, e.g., at 20 degrees Celsius.

A range of different reagent gases may be stored and delivered from a vessel as described, including many reagent gases that exhibit a relatively low vapor pressure at an operating temperature.

The list includes certain reagent gases that are presently recognized as being used and desired for use in semiconductor processing, e.g., ion implantation processes. These include: SbF₅, WF₆, MoF₆, and SiCl₄.

A longer list of reagent gases includes the following non-limiting examples.

### Phosphorus-Containing compounds:

Phosphorus trichloride PCl₃
Phosphorus tribromide PBr₃
Phosphorus dichloride fluoride PFCl₂
Phosphorus Oxychloride POCl₃
Dimethylphosphine PH(CH₃)₂
Dimethylfluorophosphine PF(CH₃)₂
Trimethylphosphine P(CH₃)₃
Trimethylphosphite P(OCH₃)₃
Trimethylphosphate PO(OCH₃)₃

### Aluminum-, gallium-, or indium containing compounds:

Fluorodimethyl-aluminum AlF(CH₃)₂
Chlorodimethyl-aluminum AlCl(CH₃)₂
Bromodimethyl-aluminum AlBr(CH₃)₂
Trimethylaluminum Al(CH₃)₃
Triethylaluminum Al(C₂H₅)₃
Triisopropylaluminum Al(C₃H₇)₃
Tripropylaluminum Al(C₃H₇)₃
Trimethylgallium Ga(CH₃)₃
Triethylindium In(C₂H₅)₃

### Silicon-Containing Compounds:

Trisilane Si₃H₈
Trichlorosilane (TCS) SiHCl₃
Silicon Tetrachloride (STC) SiCl₄
Hexachlorodisilane Si₂Cl₆
Dibromosilane SiH₂Br₂
Trbromosilane SiHBr₃
Silicon Tetrabromide SiBr₄
Monoiodosilane SiH₃I
Diiodosilane SiH₂I₂
Triiodosilane SiHI₃
Trichlorofluororsilane SiCl₃F
Dibromodifluororsilane SiBr₂F₂
Tribromofluororsilane SiBr₃F
Tetramethylsilane Si(CH₃)₄
Trimethylfluorosilane SiF(CH₃)₃
Cyclotrisiloxane Si₃H₆O₂
Trimethoxysilane SiH(OCH₃)₃
Tetramethoxysilane Si(OCH₃)₄
Tetraethyl Orthosilicate (TEOS) Si(OC₂H₅)₄

### Germanium-Containing Compounds:

Digermane Ge₂H₆
Fluorogermane GeH₃F
Germanium tetrachloride GeCl₄
Trichlorogermane GeHCl₃
Trimethylgermane GeH(CH₃)₃
Dimethyldifluororgermane GeF₂(CH₃)₂
Trimethylfluororgermane GeF(CH₃)₃
Tetra(fluoromethyl)germane Ge(CF₃)₄
Tetramethylgermane Ge(CH₃)₄
Ethylgermane GeH₃C₂H₅
Propylgermane GeH₃C₃H₁₀

### Arsenic-Containing Compounds:

Arsenic trifluoride AsF₃
Arsenic trichloride AsCl₃
Dimethylarsine AsH(CH₃)₂
Arsenic fluorodimethyl AsF(CH₃)₂
Arsenic difluoromethyl AsF₂(CH₃)
Trimethylarsine As(CH₃)₃
Tris(trifluoromethyl)arsine As(CF₃)₃

### Others:

Carbon Disulfide CS₂
Titanium tetrachloride TiCl₄
Tungsten Hexafluoride WF₆
Molybdenum Hexfluoride MoF₆
Bromine Br₂
Boron Trichloride BCl₃
Dichloro methane CH₂Cl₂
Trichloromethane CHCl₃
Carbon tetrachloride CCl₄
Dibromomethane CH₂Br₂
Tribromomethane CHBr₃
Methyl Iodide CH₃I
Ethyl Chloride C₂H₅Cl
1,1-Dichloro-2,2,2,-Trifluoroethane C₂HF₃Cl₂
Methanol CH₃OH
Ethylene oxide C₂H₄O
Boron Tribromide BBr₃
A vessel as described can be used by first adding a reagent in a liquid phase to the vessel
interior, in an amount that will not allow the liquid phase reagent to contact the open (second) end of the extension tube, regardless of the orientation of the vessel. The vessel comprises a bottom, a top, an outlet at the top, sidewalls extending from the bottom to the top, and an interior defined by the bottom, the top, and the sidewalls. The vessel includes an extension tube having a first end engaged with the outlet and a second end that is located axially from the sidewalls, and at a distance is in a range from 25 to 75 percent of the height of the vessel, and as otherwise described herein. Liquid reagent is added to the vessel interior to a level that places a surface of the liquid below the open (second) end of the extension tube, in any orientation, including with the vessel in an upright orientation, in a horizontal orientation, and in an upside-down orientation. The second end of the extension tube is preferably located so that the volume below it is maximized in every orientation. In some embodiments, this may be achieved by placing the second end of the extension tube in the center of the volume of the vessel.

In use, a vessel that contains the liquid reagent can be connected to manufacturing equipment that uses the reagent material in a gaseous form. An example of such equipment that uses gaseous reagent materials is a semiconductor processing tool, such as an ion implantation tool. In example methods, the vessel can be connected to a semiconductor processing tool, such as an ion implantation tool, and the vessel can be used to deliver a reagent gas to the semiconductor processing tool or ion implantation tool.

The described vessel is not limited to the examples provided in the specification. The examples and figures are merely exemplary to aid in understanding the scope of the claims. It is expected that a person of ordinary skill in the art would appreciate and readily conceive of the variations in design of the vessel which make use of the disclosed idea. Further, it will be appreciated that features of different embodiments can be combined unless expressly or inherently prohibited.

1. A storage vessel, comprising:
a vessel body comprising a bottom, a top, an outlet at the top, sidewalls extending from the bottom to the top, a valve at the outlet, and an interior defined by the bottom, the top, and the sidewalls, the interior comprising a volume;
a reagent material stored within the interior of the vessel body, the reagent material being in both a gas phase and a liquid phase; and
an extension tube having a first end engaged with the valve and a second end located toward a center of the interior volume such that, regardless of orientation of the storage vessel, the second end remains above a level of the liquid phase of the reagent material,
wherein the reagent material has a vapor pressure of less than 200 Torr at 20-25 degrees Celsius.

2. The storage vessel of claim 1, further comprising a reagent material stored therein selected from: SbF₅, Al(CH₃)₃, Ga(CH₃)₃, WF₆, MoF₆, and SiCl₄.

3. The storage vessel of claim 2, wherein the reagent material is antimony pentafluoride (SbF₅).

4. The storage vessel of claim 1, further comprising one or more heat transfer or thermal control features configured to promote evaporation of the liquid phase of the reagent material and maintain a desired vapor pressure within the vessel.

5. The storage vessel of claim 1, wherein the second end is located:
axially from the sidewalls, and at a distance in a range from 25 to 75 percent of a height of the vessel.

6. The storage vessel of claim 5, wherein the second end of the extension tube is located at a distance in a range from 40 to 60 percent of the height of the vessel.

7. The vessel of claim 1, wherein a liquid surface of the reagent material is located at least one quarter or one half inch below the second end of the extension tube when the storage vessel is in an upright, upside-down, or horizonal orientation.

8. The storage vessel of claim 1, wherein when the valve is opened a pressure differential is created between the interior of the vessel body and a valve exterior causing the reagent material in the gas phase to flow through the extension tube and exit the valve at the outlet of the vessel body.

9. A storage vessel, comprising:
a vessel body comprising a bottom, a top, an outlet at the top, sidewalls extending from the bottom to the top, a valve at the outlet, and an interior defined by the bottom, the top, and the sidewalls, the interior comprising a volume;
a reagent material stored within the interior of the vessel body, the reagent material being in both a gas phase and a liquid phase;
an extension tube having a first end engaged with the valve and a second end located toward a center of the interior volume such that, regardless of orientation of the storage vessel, the second end remains above a level of the liquid phase of the reagent material; and
one or more heat transfer or thermal control features configured to promote evaporation of the liquid phase of the reagent material and maintain a desired vapor pressure within the vessel.

10. The storage vessel of claim 9, wherein the reagent material has a vapor pressure of less than 200 Torr at 20-25 degrees Celsius.

11. The storage vessel of claim 9, further comprising a reagent material stored therein selected from: SbF5, Al(CH3)3, Ga(CH3)3, WF6, MoF6, and SiCl4.

12. The storage vessel of claim 11, wherein the reagent material is antimony pentafluoride (SbF5).

13. The storage vessel of claim 9, further comprising one or more heat transfer or thermal control features configured to promote evaporation of the liquid phase of the reagent material and maintain a desired vapor pressure within the vessel.

14. The storage vessel of claim 9, wherein the second end is located:
axially from the sidewalls, and
at a distance in a range from 25 to 75 percent of a height of the vessel.
